(19) United States
(12) Patent Application Publication
(10) Pub. No.: US 2017/0104982 A1
(43) Pub. Date: Apr. 13, 2017

(54) PRESENTATION OF A VIRTUAL REALITY SCENE FROM A SERIES OF IMAGES

(71) Applicant: SoliDDD Corp., Brooklyn, NY (US)

(72) Inventor: Neal Weinstock, Brooklyn, NY (US)

(21) Appl. No.: 14/879,848

(22) Filed: Oct. 9, 2015

(51) Int. Cl. H04N 13/04; G06T 19/00

(52) U.S. Cl. CPC H04N 13/044; H04N 13/0497; G06T 19/006

(57) ABSTRACT

A method and system that uses multiple views of a single image to create a three dimensional scene having a projected depth of projection. The projected depth of projection may be controlled by choosing views having a particular number of views separating them. As a user moves positions, the views are changed to display views associated with the new position of the user. The new views have the same number of views separating them to maintain a consistent depth of projection.

### FIELD OF THE INVENTION

The present invention relates generally to image display systems, and, more particularly, to an image display system that displays a virtual reality scene from images.

### BACKGROUND OF THE INVENTION

In recent years, there has been significant growth in the use and advancement of virtual reality products. Virtual reality products are used for training and education, for example, as flight simulation for pilot training, as surgery simulation for doctors, and the like. As the technology has improved and users have desired more realistic experiences, virtual reality products have been introduced into video games, movies, and amusement simulators, for example, as amusement park rides, experience simulators, and the like. The technology is even used for land development to simulate how an area may look after development has been completed.

One method of simulating a stereoscopic environment is using a stereoscope. A disk having multiple stereoscopic pairs of images would be placed in the stereoscope. These stereoscopic pairs of images have historically been taken with a stereo camera, generally two separate cameras, and the user is then presented with only those two views. Such a method does not give the feel of a three-dimensional environment. Rather, the user is only able to see the two views they are presented with and not view the images from different angles which would give the viewer the experience of interacting with the environment.

Many current virtual reality products use computer-generated graphics to simulate a three-dimensional world, or a very wide range of a viewer's potential movement in the simulated world, up to 360 degrees around and potentially inwards through the scene and around objects in the scene. As the user moves through the simulated world, the system updates the graphics to reflect the new location of the user within the simulated world.

One of the main problems with this method is that the generation of the computer graphics is very processing intensive, even if the virtual world presented to the viewer is only shown in two-dimensions (2D), and even more so if it is shown in three-dimensions (3D). Additionally, this method requires that the computer-generated graphics be presented quickly enough to account for the movements of the user. Therefore, this method requires a large bandwidth and processing power to process and present the graphics in a way that causes the user to accept the simulated three-dimensional world as an acceptable three-dimensional world.

Another virtual reality product uses a video feed to show motion video of up to a 360 degree view of a given scene, which, as above, may be only seen in two dimensions or in some sense of three dimensionality. As with the use of computer-generated graphics, this method requires a large amount of processing and bandwidth. Additionally, it involves complex and wholly new video-making techniques and equipment.

What is needed is a simplified way of displaying virtual reality imagery using multiple views from a single image, which may be a long-existing or archival photograph, and in a way that appears realistic and comparable to conventional virtual reality display methods.

### SUMMARY OF THE INVENTION

In accordance with the present invention, a method and system uses multiple views of a single image to create a three dimensional scene having a projected depth of projection. For example, the systems and methods as described herein, may be used in a virtual reality product. The product may display two stereo views at a given time, thereby producing a three dimensional scene. Using sensor data received from a device, an embodiment can present two stereo views which are associated with the position of the user.

The two stereo views are presented so that the left eye of a user is presented with a somewhat different perspective view than the right eye of the viewer. As the user looks at the stereo image pair, the viewer is presented with a three dimensional scene having a predetermined depth of projection. The depth of projection is based upon the disparity between the two images, the greater the disparity, the greater the depth of projection. For example, in an ordered set of views synthesized from a single image, as in a series of views of natural reality photographed at successive points along an arc whose center point is the subject being viewed, the views furthest apart have the greatest amount of disparity. Therefore, using the method and system described herein, an embodiment is able to control the depth of projection by using views that are separated by a specific number of views.

As the user moves positions (e.g., moves their head, moves their body, etc.), an embodiment may receive the new positioning information from sensors on the device. Using this new positioning information, an embodiment is able to display two new stereo views associated with the new position of the user. Thus, an embodiment allows the user to interact with the three dimensional scene by presenting two stereo views of a single image at a time and changing the views based upon the position of the user, while avoiding the disadvantages of conventional techniques for virtual reality imagery.

### A BRIEF DESCRIPTION OF THE DRAWINGS

FIG. 1 is a diagram illustrating the capturing of a photograph.

FIG. 2 is a diagram illustrating a synthesized left view.

FIG. 3 is a diagram illustrating a synthesized right view.

FIG. 4 is a diagram illustrating multiple synthesized views describing an arc of perspectives.

FIG. 5 is a diagram illustrating the arc of the viewer respective to the arc of the image subject matter.

FIG. 6 is a diagram illustrating the complex movement of a user in a virtual reality scene.

FIG. 7 is a diagram illustrating a user viewing views with different perspectives.

FIG. 8 is a diagram illustrating a user viewing views with a large disparity between the views.

FIG. 9 is a diagram illustrating a shifting of views as a user moves.

FIG. 10 is a block diagram showing an example viewing apparatus device.

### DETAILED DESCRIPTION OF THE INVENTION

In accordance with the present invention, an embodiment provides a method and system of displaying a virtual reality scene using multiple views created from a single two dimensional image. The two dimensional image may be, for example, a photograph, video still frame, video, poster, and the like. Additionally or alternatively, the virtual reality scene may be created with still images and also include an insertion of video within the image feed. Using the multiple views, the methods and systems as described herein display two stereo views corresponding to the position of the user. Due to the disparity between the two views, the user is presented with a simulated three dimensional environment when viewing the views. As the user changes position, for example, moves their head, walks forward or backwards, leans, and the like, the two views displayed are changed to correspond to the new position of the user. The result is something akin to a virtual reality slide show created from still images and/or video. This virtual reality product requires less processing and bandwidth than conventional virtual reality techniques. Additionally, the user is able to interact with, or move around within, the environment unlike old style stereoscopes which present only two unchanging views, no matter what position the user is in.

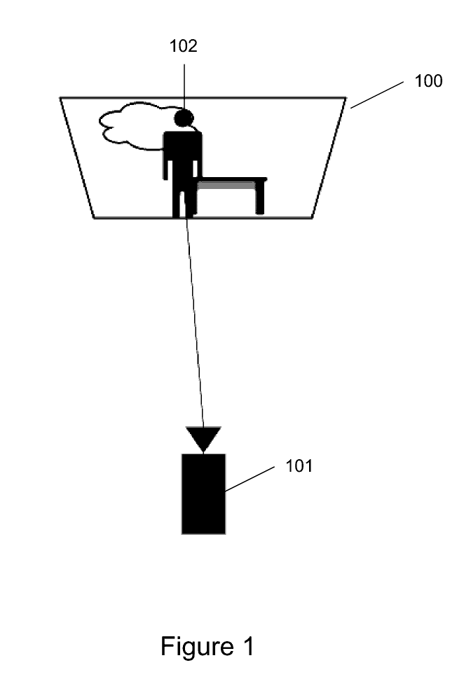

FIG. 1 shows an original two dimensional image 100. The camera 101 illustrates the actual camera position when the original image 100 was taken, with the man 102 as the focal point. From this two dimensional image 100, multiple views having different perspectives can be created. Creating multiple views from a two dimensional image (referred to as “single image” or “image” herein) is based upon a described arc around the subject matter or a focal point in the image. In creating multiple views from a single image, different view creation techniques may be employed. One view creation technique includes creating a depth map of the image. The depth map may be created for the entire image or may be created for different objects within the image. For example, a particular object within the image may be of particular interest, so a depth map may be created for this object and then a separate depth map may created for the remaining image. Alternatively, a depth map may only be created for the object of interest and no depth map may be created for the remaining image. In creating the depth map, the image may be converted to grayscale where pixels corresponding to locations toward the forefront of the image have a low grayscale value, for example, a value of 0. Pixels corresponding to locations toward the background of the image may have a high grayscale value, for example, a value of 255.

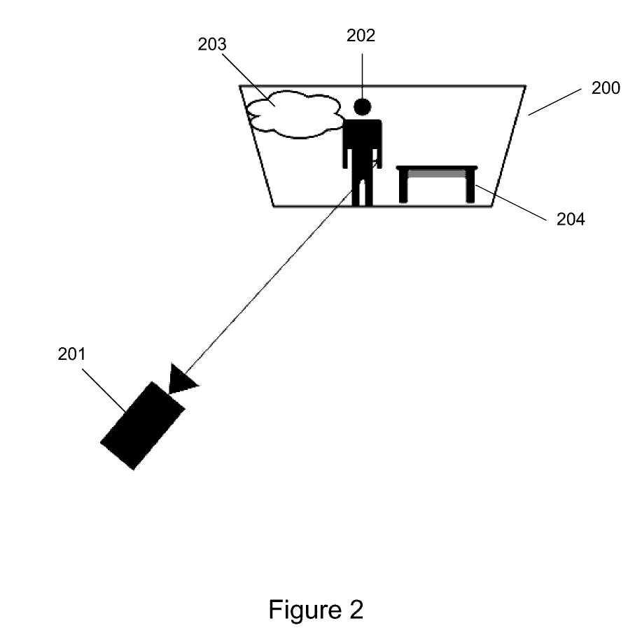

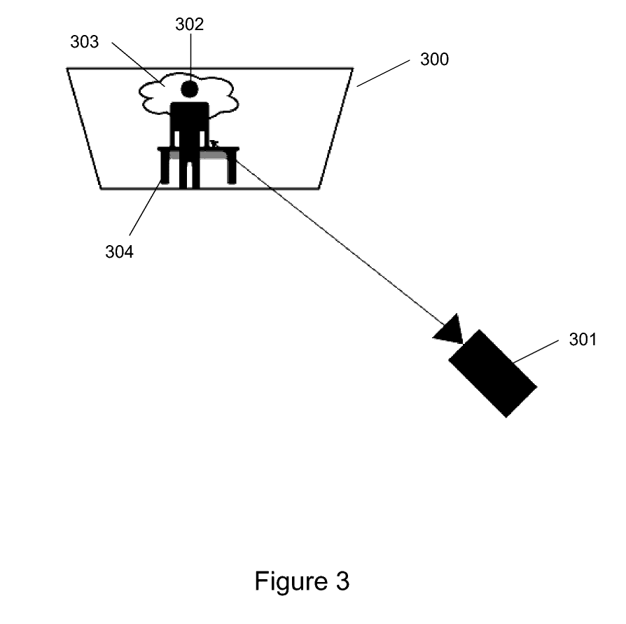

The original image and depth map(s) may then be run through warping software. This software creates multiple views of the image by shifting perspective of the still image using the depth map. The warping software is able to use the grayscale depth map to identify how much each pixel should be shifted based upon how much the perspective is shifted. Pixels closer to the focus area end up being shifted by less than pixels further from the focus area. As an example, FIG. 2 illustrates a synthesized extreme left view 200. This view 200 was created from the original image 100, in FIG. 1, using a view creation technique. Using the focal point of the man 202, the software has shifted the remaining objects 203 and 204 in the view 200 to simulate the desired perspective with the appropriate depth values. The resulting view 200 appears as if the original image was taken from the extreme left camera position 201. FIG. 3 illustrates a synthesized extreme right view 300. Again, this view 300 was created from the original image 100, in FIG. 1, with the man as the focal point 302. As can be seen, the remaining objects 303 and 304 have been shifted to simulate the desired perspective with the appropriate depth values, resulting in a view 300 that appears as if it was taken from the extreme right camera position 301.

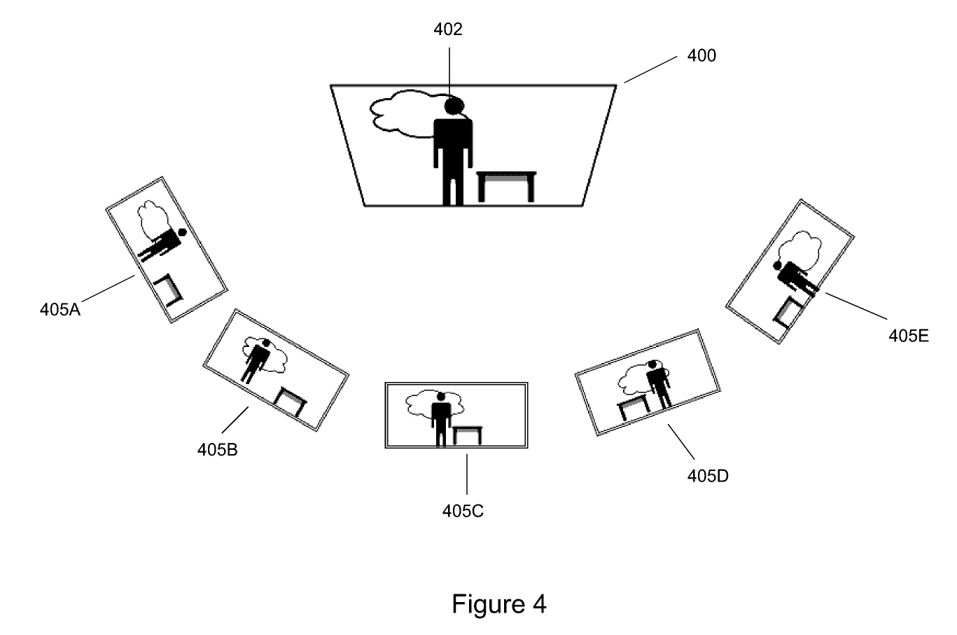

Using the warping software a user can create as many views from the single image as is desired. For example, referring to FIG. 4, from the original two dimensional image 400, multiple views 401A-401 E have been created. Each of the different views 401A-401E has been created at equal distances from the central or focal point of the original image 400. As can be seen in FIG. 4, each of the views 401A-401E show different perspectives of the image with the man 402 from the original image 400 being the focal point. Thus, the resulting multiple views 401A-401E describe the arc of perspectives from the central point 402 of the original image 400. This image arc can be used for typical three dimensional viewing in an autostereo display where the images are interlaced together and viewed through a view selector. However, for use in a virtual reality product, the ability for the user to move must be taken into account.

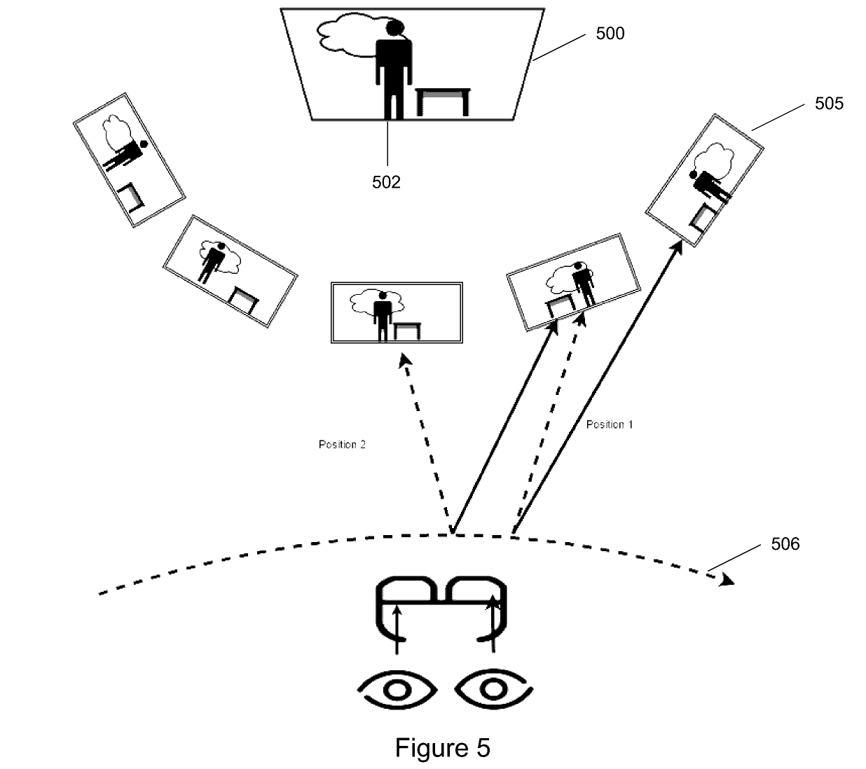

To create an accurate sense of stereo, stereo views that describe positions along an arc around the subject must be created at all points of the viewer's perspective located along an arc around the pivotal center of the viewer's head. Therefore, in addition to the views being synthesized for the arc around the central point of the original image, views are also synthesized at each desired position along an arc described by a user turning their head. FIG. 5 illustrates the arc around the central point 502 of the original image 500 that the views 505 form. Additionally, FIG. 5 illustrates the arc 506 relating to the movement of the user as they turn their head from side to side. Thus, in the creation of the views, a view is made for each viewing position using, for example, the warping software. Then from each of those views, multiple views are created to account for the arc around the focal point of the original image. Alternatively, these steps may be combined into a single step using a more complex algorithm.

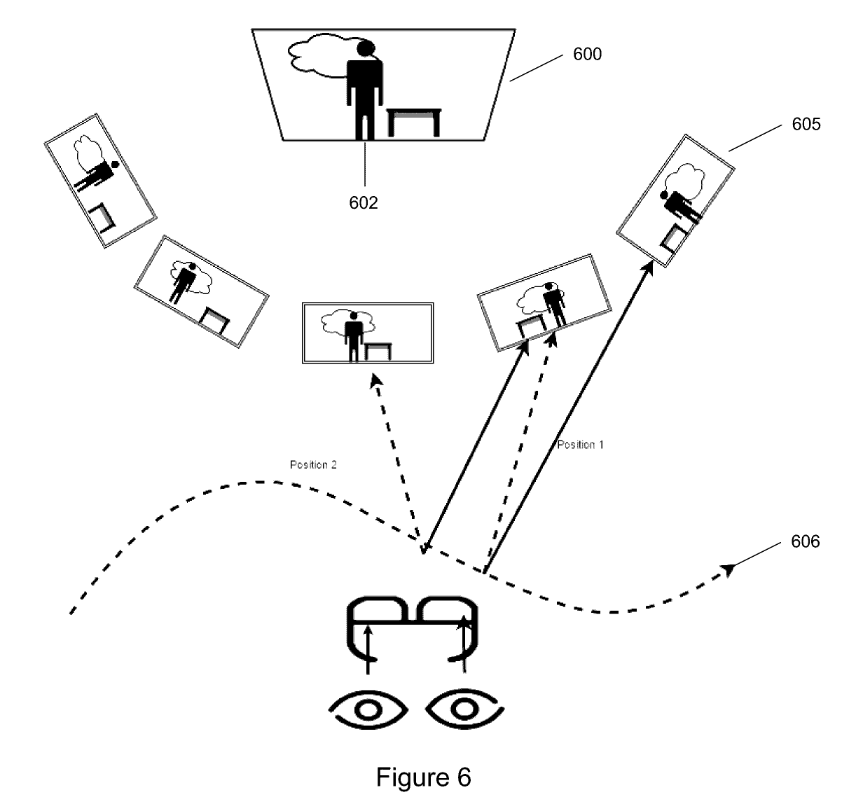

Using the previous steps accounts for a user viewing a simulated three-dimensional scene by only moving their head. As can be understood, a virtual reality product should also account for the user moving their whole body. As such, the arc as described around the viewer can be moved along a more complex line as the user combines head movement with walking FIG. 6 illustrates a more complicated arc pattern with relation to the user 606. In such a scenario, views would need to be created for each body movement that a user could make and additionally a view arc at each of those positions to account for the fact that the user could move their head at each of these viewing positions. The movement of the user is unpredictable, so the creation of these views may be completed using software on the local device as the user is moving, rather than creating the views beforehand.

Once the multiple views are created, an embodiment may use these views to provide the simulated three dimensional environment using a virtual reality viewing apparatus. For example, the viewing apparatus may include a portable information handling device (e.g., smart phone, tablet, etc.) that may be positioned on or within head gear which positions the device in front of the user's eyes. Alternatively, the viewing apparatus may include a headset, for example, those used in traditional virtual reality viewing products, or goggles, for example, those used in newer virtual reality viewing products. The methods and systems as described herein are described in connection with a virtual reality product, however, as can be understood by one skilled in the art, the methods and systems may be applied to other products or techniques, for example, three dimensional television viewing, a three dimensional simulator, and the like.

One embodiment may obtain at least a portion of the multiple views for use in providing a three dimensional scene. In obtaining the views, an embodiment may receive the views, for example, through a continuous feed, over wired or wireless communication methods, and the like. Alternatively, an embodiment may access a storage location (e.g., cloud storage, local storage, remote storage, etc.) and request the views. As another example, the views may be contained within a storage location on the apparatus and may be accessed for use by an embodiment. In other words, the obtaining of the views may be a passive or active action by an embodiment.

The multiple views may be ordered. For example, the views may be sequential based upon the image the views were created from. As an example, view one may comprise the view associated with the leftmost viewing perspective of the image. View two hundred may comprise the view associated with the rightmost viewing perspective of the image. Such a description of the views is used for illustration purposes only. The views are not necessarily from left to right of the image and may include views from top to bottom of the image, centermost to outside edges, based upon an arc around the user, and the like. The views may also be ordered using different schemes rather than sequentially, for example, the views may be ordered by position, viewing angle, and the like.

An embodiment may then receive sensor data indicating a positioning of the user, using the three dimensional simulation system. The positioning of the user may include, for example, the relative position of the user (e.g., the position of the user with respect to the environment), the actual position of the user (e.g., global positioning system (GPS) information), and the like. Positioning data may indicate the position of the user's entire body, parts of the user's body (e.g., head position, torso position, etc.), the user's eyes (e.g., the direction the user is looking, spacing of the eyes, etc.), and the like. The positioning data may be captured from sensors located on the viewing apparatus. For example, the viewing apparatus may be equipped with sensors that can capture position information for the viewing apparatus. As an example, a smart phone may be equipped with gyroscopes, accelerometers, cameras, and the like, which can identify the position of the smart phone and additionally capture information relating to the position of the user (e.g., the position of the user's head or eyes, etc.). Positioning data may also be captured from sensors not located on the viewing apparatus, for example, sensors placed on the user's body, sensors located in the environment (e.g., cameras on the wall, sensors on the floor, etc.), and the like.

Based upon the positioning of the user, an embodiment may display at least a portion of one of the views of the image. This portion of the image may be displayed at a location corresponding to or associated with a position of the left eye of a user. The portion may include the entire view or may just include a portion of the view. The determination of how much of the view is displayed may be dependent on the position of the user as explained in more detail below. As a working example, if the positioning data indicates that a user is looking at the image from a position corresponding to the left most view of the image, stereo view one (which may correspond to the left most view of the image) may be displayed for viewing by the left eye of the user. Additionally, at least a portion of another one of the views may be displayed at a location corresponding to or associated with a position of the right eye of the user. Using the working example, stereo view two may be displayed for viewing by the right eye of the user. The portion of the second view, referred to as the first right eye view for ease of understanding, displayed should be equivalent to the portion of the first view, referred to as the first left eye view for ease of understanding. In other words, for example, if in the first left eye view only the lower left portion of the view, equaling 25% of the overall view, is displayed, then only the lower left portion of the first right eye view, equaling 25% of the overall view, should be displayed.

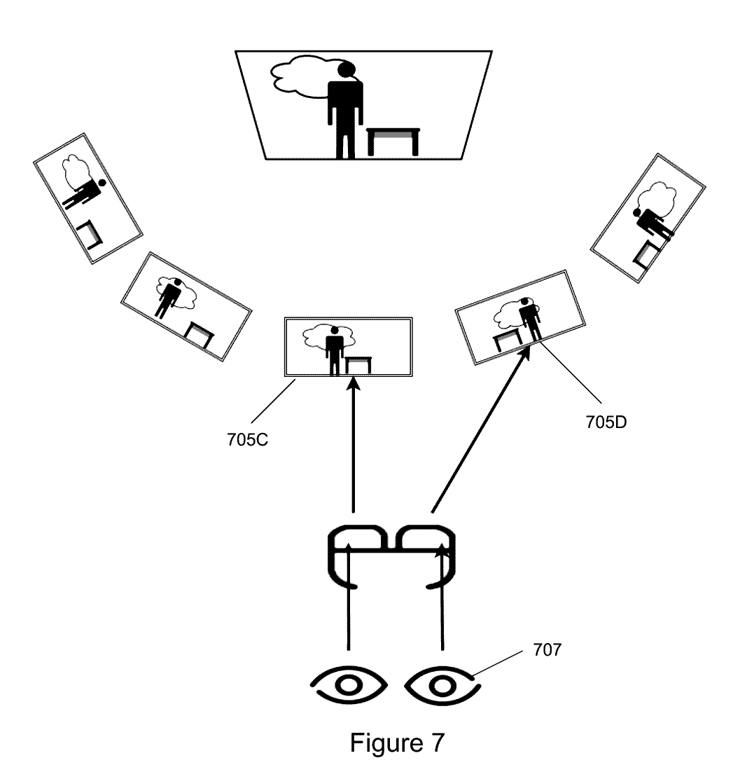

The views which are chosen to be displayed may be based upon the sequence of the views. Additionally, the views which are chosen to be displayed may be based upon a desired depth of projection for the three dimensional scene. The depth of projection is how far the three dimensional scene appears to be projected. As shown in FIG. 7, a sense of depth is created by the viewer's eyes 707 each seeing one of two views 705C (seen by the left eye) and 705D (seen by the right eye) where each of the two views have a different perspective.

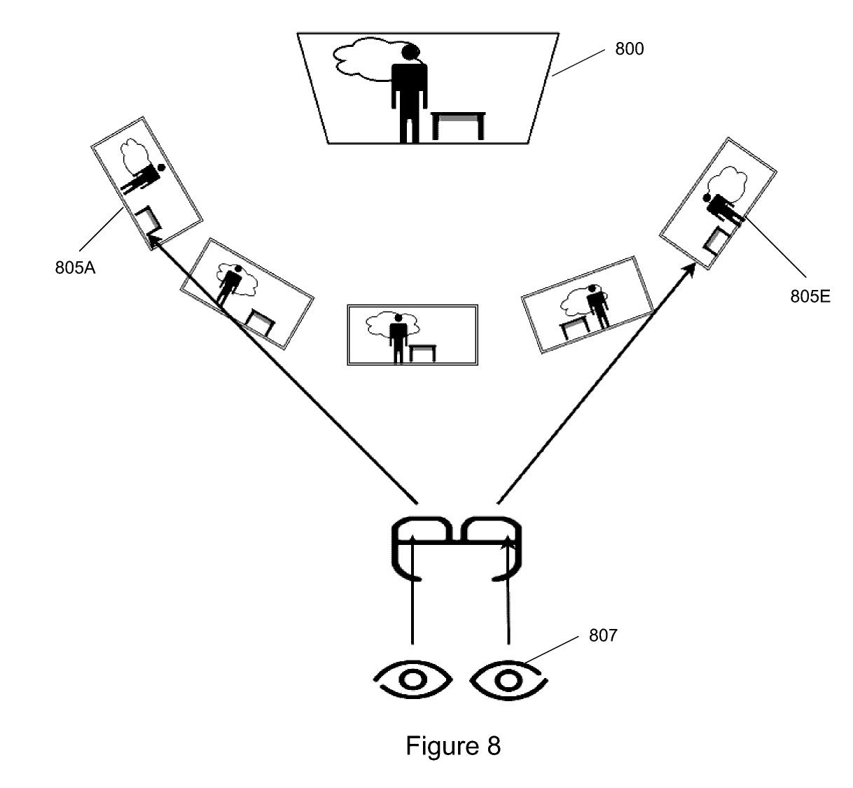

The depth of projection is based upon how much disparity exists between the two views displayed. As an example, assume two hundred total views exist for a single image, and view one is equal to the left most view and view two hundred is equal to the right most view. If view one is displayed for the left eye and view two (i.e., the next sequential view) is displayed for the right eye, the disparity between the views will be the least. Therefore, the depth of projection will be the smallest. If, however, view one is displayed for the left eye and view two hundred is displayed for the right eye, the disparity between the views will be the greatest. Therefore, the depth of projection will be the largest. In other words, referring to FIG. 8, a larger sense of depth is created by a user viewing 807 two views 805A and 805E with a wider disparity. The widest disparity is seen between the two views located farthest apart along the arc surrounding the original image 800. Thus, based upon the desired depth of projection, the views can be chosen to achieve the desired depth of projection.

Additionally, different users perceive depth differently. Part of this perception may be based upon the spacing of the user's eyes. For example, if the spacing of a user's eyes is close together (e.g., a child's eyes), the user may perceive a greater depth of projection than someone with eyes that are further apart (e.g., an adult), even if the disparity or variance between the views is the same for each of the users. Based upon this information, the views for display may be chosen by an embodiment. As an example, assume a user wants a depth of projection that corresponds to the disparity between views one and twelve. An embodiment may display view one for the left eye of the user and may display view twelve for the right eye of the user, resulting in the desired depth of projection.

The views displayed or the number of views between the views displayed may be selected automatically by an embodiment. For example, an embodiment may receive sensor information regarding the spacing of the user's eyes. Using this information an embodiment may chose the views which correspond to the spacing of the user's eyes, based upon a predetermined or default depth of projection. Thus, as can be understood, the child as used earlier would be presented with views having a smaller disparity than the adult who would be presented with views having a larger disparity. Alternatively, the views displayed or the number of views between the views displayed may be selected manually by a user. For example, an embodiment may include a control which allows the viewer to change the depth of projection or disparity between the views. The automatic selection and manual selection may be used in conjunction with each other. For example, an embodiment may automatically select the views and a user may then provide input that changes the views displayed.

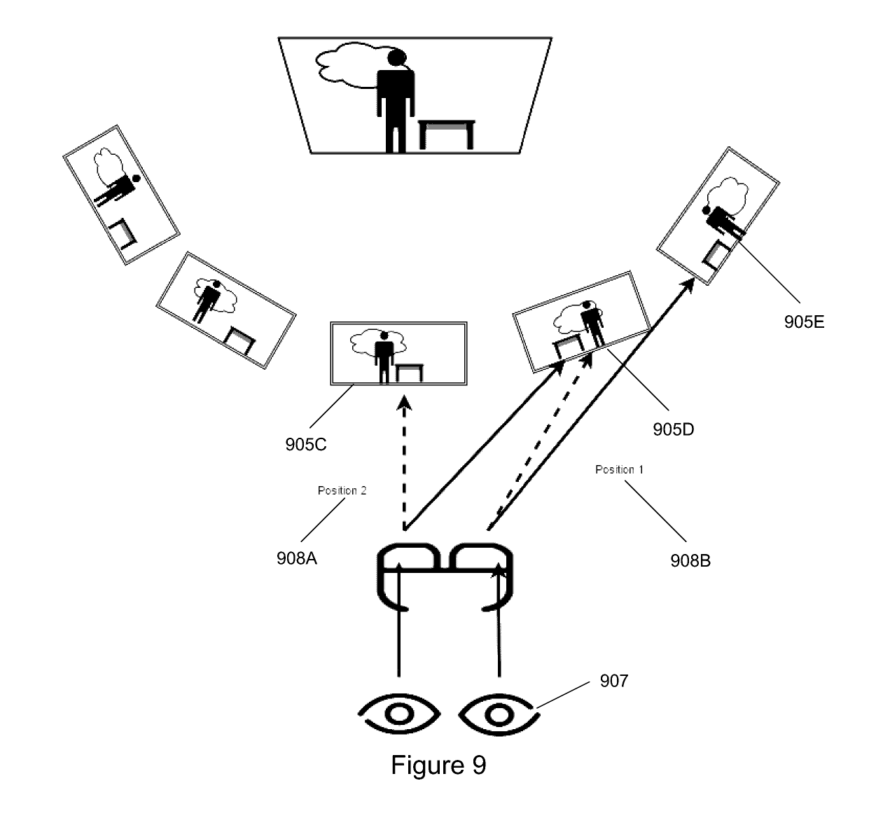

As a user is viewing the three dimensional environment, they may move (e.g., move their head, walk forward, lean backward, look up, etc.). An increased sense of viewer perspective is created by shifting views as the user's head moves. For example, referring to FIG. 9, if a user is looking 907 in a direction relating to position 1 908B, the user may be presented with views 905D (for the left eye) and 905E (for the right eye). If, however, the user moves their head to the left corresponding to position 2 908A, the user may be presented with views 905C (for the left eye) and 905D (for the right eye).

Therefore, using sensors, which may be the same or different than those discussed before, an embodiment may receive data indicating new positioning data associated with the position of the user based on the movement of the user. Based upon this new position data, an embodiment may change the views displayed on the viewing apparatus. As an example, a portion of another view may be displayed at the location associated with the position of the left eye of the user, referred to as the second left eye view for ease of understanding. Additionally, based on the new position data, a portion of another view may be displayed at the location associated with the position of the right eye of the user, referred to as the second right eye view for ease of understanding. In other words, when the user moves, the first left eye view is replaced with the second left eye view. Similarly, the first right eye view is replaced with a second right eye view.

The first left eye view and the second left eye view will be different from each other. Additionally, the first right eye view and second right eye view will be different from each other. However, depending on the total number of views and/or the number of separating views, the second left eye view and second right eye view may not be completely unique from the first left eye view and first right eye view. For example, the second right eye view may be the same view as the first left eye view. As an example, assume there are three total views of the single image. As the user is looking to the left, view one is displayed as the first left eye view and view two is displayed as the first right eye view. When the user moves their head to the right, view two, which was used for the first right eye view, is displayed now as the second left eye view and view three is displayed as the second right eye view.

In displaying the second set of views (i.e., the second left eye view and second right eye view) the difference between the two views will be the same as the difference between the two views of the first set of views (i.e., the first left eye view and first right eye view). In other words, in order to maintain a consistent depth of projection while the user is moving, the views must maintain the same disparity between them. As an example, if the first set of views have three separating views (e.g., the first left eye view is view one and the first right eye view is view five), the second set of views must have three separating views (e.g., the second left eye view is view two and the second right eye view is view six). Once the views are displayed, the depth of projection could be adjusted, for example, manually by a user. As an example, if as a user moves they want to change the depth of projection, they could manually adjust it to change the disparity between the views. Additionally, the portion of the view that is displayed may be the same between the two view sets. For example, if the lower left corner of the first left eye view is displayed, then the lower left corner of the second left eye view may be displayed to maintain a consistent focal point between the view sets.

Once the views are displayed, the user can interact with the scene. Not only can the user adjust the views displayed as discussed above by moving to the left or right or changing the viewing perspective, but the user can interact with the scene by moving in and out of the scene. For example, as the user moves into the scene (e.g., moving forward, leaning forward, indicating a forward motion, etc.) the view may be enlarged, for example, zooming into the view, at the focal point of the user. This may give the impression that the user is closer to the focal point. Similarly, if the user moves out of the scene, the view may be reduced, for example, zooming out of the view, at the focal point of the user, giving the impression that the user is further from the focal point. In other words, the view displayed is not changed, but the amount of the view that can be seen by the user is changed. This is different than typical virtual reality products which generate a completely new image based upon the position of the user. Additionally, if only a portion of the view is displayed, the user may move their head or body as if they are looking around and see different portions of the view. For example, if the portion being displayed is the center of the view comprising 50% of the total view, as the user looks up (e.g., tilts their head up) a different portion of the view may be displayed, for example the upper center of the view.

As an overall example, one hundred views have been created from a single photograph. When the user first puts on the virtual reality product they are presented with views forty-eight for the left eye and fifty for the right eye, corresponding to roughly the center of the image. As the user moves their head to the left a little bit, they are presented with views forty-seven for the left eye and forty-nine for the right eye. If instead, the user moves their head to the right a little bit, they are presented with views forty-nine for the left eye and fifty-one for the right eye. The difference in the view numbers, one separating view for this example, remains consistent as the views are displayed to ensure a consistent depth of projection. If the user moves their head as far to the left as the views allow, the left eye will be presented with view ninety-nine and the right eye will be presented with view one.

Additionally, the user can move into the three dimensional scene by moving forward, for example, by leaning forward. In this instance, assuming the user only moves forward, the views currently being displayed will be enlarged to give the impression of moving into the scene. Similarly, the user can move out of the three dimensional scene by moving backward, which results in the views currently being displayed being reduced giving the impression of moving out of the scene.

Accordingly, the described methods and systems sense movement of a user and relate that movement to different views of a single image. As the user moves, the views change from one fully rendered view image to another based upon the position of the user, giving the impression of interacting with the simulated three dimensional scene or environment. This is in contrast to the common multiple image virtual reality products which present different views of polygons in computer memory or a different section of a single 360 degree video image based upon the movement of the user. The multiple views created from the single image describe an arc around the subject matter or focal point of the image. In presentation of a virtual reality three dimensional scene, the views displayed are based upon an arc positioned around the user. Using the methods and systems described herein, the presentation of the displayed views accounts for both the subject matter arc and the user arc, thus giving the user a sense of stereo from any given place the viewer is on any given arc and view.

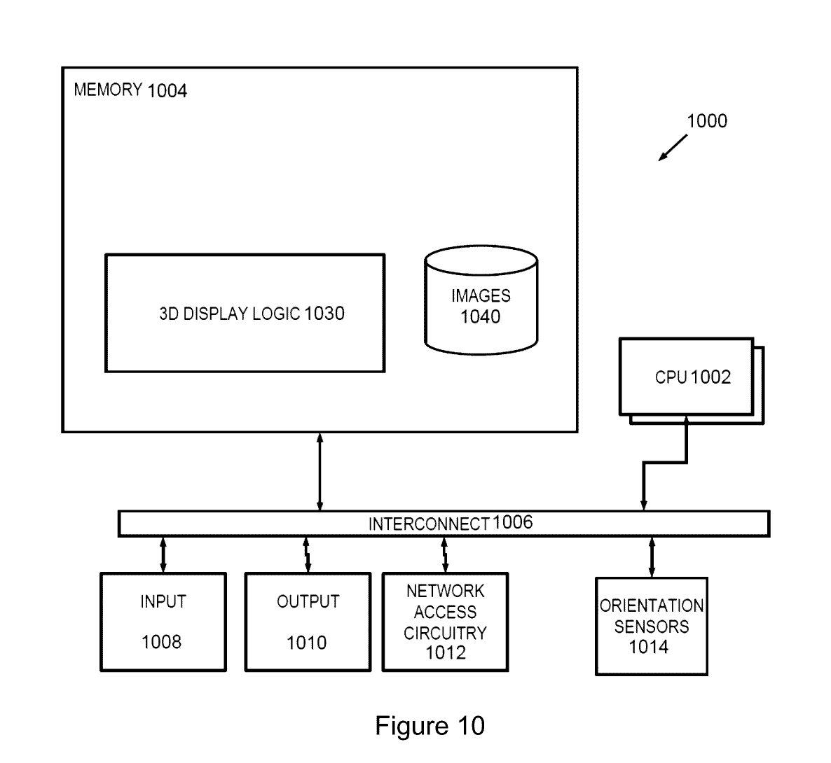

Referring to FIG. 10, a device 1000, for example, that which is used for the viewing apparatus, is described. The device 1000 includes one or more microprocessors 1002 (collectively referred to as CPU 1002) that retrieve data and/or instructions from memory 1004 and execute retrieved instructions in a conventional manner. Memory 1004 can include any tangible computer readable media, e.g., persistent memory such as magnetic and/or optical disks, ROM, and PROM and volatile memory such as RAM. CPU 1002 and memory 1004 are connected to one another through a conventional interconnect 1006, which is a bus in this illustrative embodiment and which connects CPU 1002 and memory 1004 to one or more input devices 1008 and/or output devices 1010, network access circuitry 1012, and orientation sensors 1014. Input devices 1008 can include, for example, a keyboard, a keypad, a touch-sensitive screen, a mouse, and a microphone. Output devices 1010 can include a display-such as a liquid crystal display (LCD)-and one or more loudspeakers. Network access circuitry 1012 sends and receives data through computer networks. Orientation sensors 1014 measure orientation of the device 1000 in three dimensions and report measured orientation through interconnect 1006 to CPU 1002. These orientation sensors may include, for example, an accelerometer, gyroscope, and the like, and may be used in identifying the position of the user.

A number of components of the device 1000 are stored in memory 1004. In particular, 3D display logic 1030 is all or part of one or more computer processes executing within CPU 1002 from memory 1004 in this illustrative embodiment but can also be implemented, in whole or in part, using digital logic circuitry. As used herein, “logic” refers to (i) logic implemented as computer instructions and/or data within one or more computer processes and/or (ii) logic implemented in electronic circuitry. Images 1040 is data representing one or more images and/or views which may be stored in memory 1004.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for displaying a virtual reality scene, the method comprising:
obtaining at least three views of a single image, wherein the at least three views are ordered;
receiving sensor data indicating a positioning of a user;
based on the positioning of the user, displaying at least a portion of a first of the at least three views at a location associated with a position of a left eye of the user and displaying at least a portion of a second of the at least three views at a location associated with a position of a right eye of the user;
the displayed views creating a three dimensional scene when viewed by the user, the three dimensional scene having a predetermined depth of projection based on the displayed views;
receiving new sensor data indicating a new positioning of the user; and
based on the new positioning of the user, displaying at least a portion of one of the at least three views at the location associated with a position of a left eye of the user, and displaying at least a portion of another of the at least three views at the location associated with a position of a right eye of the user;
wherein the one of the at least three views is different from the first of the at least three views and wherein the another of the at least three views is different from the second of the at least three views.

2. The method of claim 1, wherein the displaying at least a portion of a first of the at least three views comprises displaying the view ordered first, and wherein the displaying at least a portion of a second of the at least three views comprises displaying the view ordered second; and
wherein the displaying at least a portion of one of the at least three views comprises displaying the view ordered third, and wherein the displaying at least a portion of another of the at least three views comprises displaying the view ordered first.

3. The method of claim 1, wherein the first of the at least three views and the second of the at least three views are separated by a number of separating views; and
wherein the number of separating views is equal to a number of views separating the one of the at least three views and the another of the at least three views.

4. The method of claim 3, wherein the number of separating views is at least one.

5. The method of claim 1, wherein the predetermined depth of projection is selectable by the user.

6. The method of claim 1, wherein the predetermined depth of projection is increased by selecting views for display having an increased number of views separating the displayed views.

7. The method of claim 1, wherein the predetermined depth of projection is based upon a distance between the left eye of the user and the right eye of the user.

8. The method of claim 1, further comprising receiving sensor data indicating the user is moving into the three dimensional scene; and
enlarging the displayed views based upon the sensor data indicating the user is moving into the three dimensional scene.

9. A device for displaying a virtual reality scene, the device comprising:
a processor;
a memory device that stores instructions executable by the processor to:
receive at least three views of a single image, wherein the at least three views are ordered;
receive sensor data indicating a positioning of a user;
based on the positioning of the user, display at least a portion of a first of the at least three views at a location associated with a position of a left eye of the user and display at least a portion of a second of the at least three views at a location associated with a position of a right eye of the user;
the displayed views creating a three dimensional scene when viewed by the user, the three dimensional scene having a predetermined depth of projection based on the displayed views;
receive new sensor data indicating a new positioning of the user; and
based on the new positioning of the user, display at least a portion of one of the at least three views at the location associated with a position of a left eye of the user, and display at least a portion of another of the at least three views at the location associated with a position of a right eye of the user;
wherein the one of the at least three views is different from the first of the at least three views and wherein the another of the at least three views is different from the second of the at least three views.

10. The device of claim 9, wherein to display at least a portion of a first of the at least three views comprises displaying the view ordered first, and wherein to display at least a portion of a second of the at least three views comprises displaying the view ordered second; and
wherein to display at least a portion of one of the at least three views comprises displaying the view ordered third, and wherein to display at least a portion of another of the at least three views comprises displaying the view ordered first.

11. The device of claim 9, wherein the first of the at least three views and the second of the at least three views are separated by a number of separating views; and
wherein the number of separating views is equal to a number of views separating the one of the at least three views and the another of the at least three views.

12. The device of claim 11, wherein the number of separating views is at least one.

13. The device of claim 9, wherein the predetermined depth of projection is selectable by the user.

14. The device of claim 9, wherein the predetermined depth of projection is increased by selecting views for display having an increased number of views separating the displayed views.

15. The device of claim 9, wherein the predetermined depth of projection is based upon a distance between the left eye of the user and the right eye of the user.

16. The device of claim 9, wherein the instructions are further executable by the processor to receive sensor data indicating the user is moving into the three dimensional scene; and
to enlarge the displayed views based upon the sensor data indicating the user is moving into the three dimensional scene.

17. A tangible computer readable medium, comprising:
computer instructions which are executable by a processor to display a virtual reality scene and comprising:
code that receives at least three views of a single image, wherein the at least three views are ordered;
code that receives sensor data indicating a positioning of a user;
based on the positioning of the user, code that displays at least a portion of a first of the at least three views at a location associated with a position of a left eye of the user and code that displays at least a portion of a second of the at least three views at a location associated with a position of a right eye of the user;
the displayed views creating a three dimensional scene when viewed by the user, the three dimensional scene having a predetermined depth of projection based on the displayed views;
code that receives new sensor data indicating a new positioning of the user; and
based on the new positioning of the user, code that displays at least a portion of one of the at least three views at the location associated with a position of a left eye of the user, and code that displays at least a portion of another of the at least three views at the location associated with a position of a right eye of the user;
wherein the one of the at least three views is different from the first of the at least three views and wherein the another of the at least three views is different from the second of the at least three views.

18. The computer readable medium of claim 17, wherein the first of the at least three views and the second of the at least three views are separated by a number of separating views; and
wherein the number of separating views is equal to a number of views separating the one of the at least three views and the another of the at least three views.

19. The computer readable medium of claim 17, wherein the predetermined depth of projection is increased by selecting views for display having an increased number of views separating the displayed views.

20. The computer readable medium of claim 17, wherein the computer instructions further comprise code that receives sensor data indicating the user is moving into the three dimensional scene; and
code that enlarges the displayed views based upon the sensor data indicating the user is moving into the three dimensional scene.
